(19) United States
(12) Patent Application Publication
(10) Pub. No.: US 2010/0278065 A1
(43) Pub. Date: Nov. 4, 2010

(54) Traffic Load Estimation for Access Point Functionality Enabled Mobile Devices

(75) Inventors: Yanjun Sun, Richardson, TX (US); Ariton E. Xhafa, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INC., Dallas, TX (US)

(21) Appl. No.: 12/770,455

(22) Filed: Apr. 29, 2010

Related U.S. Application Data
(60) Provisional application No. 61/173,775, filed on Apr. 29, 2009.

(51) Int. Cl. H04L 12/26; H04W 24/00

(52) U.S. Cl. 370/252

(57) ABSTRACT

Embodiments of the invention comprise a system and method for estimating a traffic load on a wireless network. An access point notifies a station that the access point will not receive transmissions during a first quiet period. After the first quiet period, the access point monitors the wireless network during a first monitoring period. If no transmissions are received during the first monitoring period, the access point notifies the station that it will not receive transmissions during a second quiet period. The second quiet period has an equal or longer duration than the first quiet period. The access point alternates between monitoring periods and quiet periods and progressively expands the duration of the quiet periods as long as no transmissions are received during the monitoring periods. If a station notifies the access point that packets are pending at the device, the monitoring period is extended to handle these packets immediately.

### CROSS-REFERENCE TO RELATED APPLICATIONS

The present application claims the benefit of the filing date of U.S. Provisional Patent Application No. 61/173,775, which is titled “Traffic Load Estimation for Soft AP Enabled Mobile Devices” and was filed Apr. 29, 2009, the disclosure of which is hereby incorporated by reference herein in its entirety.

### TECHNICAL FIELD

Embodiments of the invention are directed, in general, to estimation of traffic loads to be supported by a device at the MAC layer and, more specifically, to providing power savings by identifying when an access point device can be turned off without sacrificing network performance.

### BACKGROUND

Embodiments of the invention are directed, in general, to communication systems and, more specifically, methods of improving power efficiency in electronic devices. Early use of “Wi-Fi” or wireless local area network (WLAN) devices based on the IEEE 802.11 standards was typically limited to Personal Computers (PC) and wireless Access Points (AP). The number of other Wi-Fi-enabled devices, such as Consumer Electronic (CE) devices and mobile handsets, is increasing rapidly. The incorporation of Wi-Fi into CE and handset devices in addition to PCs and Access Points enables new usage models for users. For example, a user may want to use his or her cell phone to share, show, print, and synchronize content by connecting with CE devices or mobile handsets of other users through Wi-Fi technologies, with or without an infrastructure network nearby.

Responding to this need, a Wi-Fi Alliance task group is working on a new standard called Wi-Fi Peer-to-Peer, to allow CE and mobile handsets to connect to each other in an ad hoc and peer-to-peer way. One way to achieve this is to provide the Access Point functionality in software (including firmware) at a device so that the device serves as group master or group owner, behaving just like a typical AP. Although the examples used herein include Access Point functionality implemented in software, the present invention also includes embodiments in which such energy-efficient traffic load estimation at an Access Point is alternatively or additionally implemented in hardware or firmware.

With the AP functionality added to CE devices or mobile handsets, other devices may act as a client and set up connections with the mobile AP in the same way as they connection to a conventional AP. Access Point functionality is provided by software or firmware in most applications. This scheme is referred to as Soft Access Point (SAP) herein. Wi-Fi client or station functionalities are a subset of SAP.

SAP is often implemented on a CE or mobile handset that is battery powered. Limited battery capacity can be a challenge for CE and mobile SAP devices. The SAP design needs to be very power efficient. A conventional AP, however, typically does not have this concern because it has an unlimited power supply. In conventional AP design, the AP does not turn off its radio or “sleep” even if there is no traffic. Such idle channel monitoring consumes a lot of energy and thus is unsuitable for SAP.

Current access point devices complying with the 802.11 standard do not enter a sleep mode wherein the access point's radio is turned off and on during its operation. Instead, the access point radio is always in an “on” or “awake” state for idle channel monitoring, so there is no need for known access point devices to estimate traffic loads for power saving.

### SUMMARY

Embodiments of the invention save energy by turning off the access point device's radio from time to time when there are no packets to be exchanged or when a packet exchange would not improve network performance. The efficiency of the power-control or micro rate control algorithm depends on how accurately the AP estimates traffic loads. The present disclosure describes techniques to help the micro rate control algorithm accurately estimate traffic loads so that the AP can make better decisions on when to switch its radio on and off. This results in energy savings while maintaining the same level of throughput and latency as an AP that operates in an always-on configuration. Embodiments of the invention estimate the traffic loads to be supported by an AP device at the MAC layer. Such information is used by the power-saving schemes to make better decisions on when to switch radio states. On a SAP-enabled mobile device, the traffic load estimation ensures that the radio can be turned off without sacrificing network performance. The traffic load estimation is used by a micro rate control algorithm to determine when and how long to switch the SAP radio off and on. The embodiments of the traffic load estimation process described herein are compliant with the IEEE 802.11 standards, are passive-measurement based, and can handle a wide range of traffic loads.

Embodiments of the invention provide an access point comprising a wireless receiver for receiving data from a network, and a wireless transmitter for transmitting data to one or more devices on the network. The access point further comprises a processor coupled to the receiver and the transmitter, the processor adapted to process data packets received from the network and to generate messages to be transmitted to the one or more devices. The processor operates to send first transmit instructions to the one or more devices. The first transmit instructions identify a first period of absence. Access point monitors a transmit channel during a monitoring period following the first period of absence. When no packets are received during the monitoring period, the processor sends second transmit instructions to the one or more devices. The second transmit instructions identify a second period of absence. The second period of absence may be equal to or longer than the first period of absence.

The access point adapts to increasing traffic loads by extending monitoring periods—or delaying periods of absence—to allow pending packets to be transmitted without delay. If packets are received or transmitted during the monitoring period, then the access point restarts the monitoring period. The access point then monitors the transmit channel during a new monitoring period. During a monitoring period, if a device on the network notifies the access point that it has pending packets, then the access point immediately extends the monitoring period to handle the pending packets before a next period of absence begins.

The length of the second period of absence may be an integer multiple of the length of the first period of absence. Alternatively, the length of the second period of absence may be longer than the length of the first period of absence by a predetermined percentage or by a predetermined duration.

The access point processor further operates to place the receiver in a sleep mode during a portion of the period of absence. The sleep mode prevents the receiver from receiving data from the network. The access point receiver is in an active mode at times outside the period of absence. The transmit instructions may identify a start time and a duration for the period of absence. The transmit instructions may further identify an interval separating a plurality of periods of absence.

The access point may further comprise a memory coupled to the processor. The memory storing access point functionality software. The access point may also comprise a battery that provides power to the receiver, interface, and processor.

In another embodiment, a method comprises instructing a device to not transmit during a first quiet period, monitoring a transmission medium during a monitoring period following the first quiet period, and when no data is received from the device during the monitoring period, instructing the device to not transmit during a second quiet period, the second quiet period longer than the first quiet period. The length of the second quiet period may be an integer multiple of the first quiet period length, a predetermined percentage longer than the first quiet period, or a predetermined duration longer than the first quiet period. A clear to send to self (CTS2Self) frame, a transmission opportunity (TXOP) frame, a notice of absence (NoA), or an opportunistic power-save message may be used to instruct the device to not transmit.

The method may further comprise placing a receiver in a sleep mode during a portion of the first quiet period, placing the receiver in an active mode during the monitoring period, and returning the receiver to the sleep mode during a portion of the second quiet period. The receiver may be placed in an active mode prior to a start time of the monitoring window. Placing the receiver in a sleep mode may reduce the energy used by the receiver.

Another embodiment comprises notifying a station on a wireless network that an access point will not receive transmissions during a first designated period. The access point monitors the wireless network during a first monitoring period beginning at an end of the first designated period. When no transmissions are received from the station during the first monitoring period, the access point notifying the station that it will not receive transmissions during a second designated period. The second designated period has a longer duration than the first designated period. The access point monitors the wireless network during a second monitoring period beginning at an end of the second designated period. The duration of the second monitoring period corresponds to the duration of the first monitoring period. When no transmission is received from the station during the second monitoring period, the access point notifies the station that it will not receive transmissions during a third designated period. The third designated period has a longer duration than both the first designated period and the second designated period.

The length of the second designated period may be longer than the length of the first designated period by a measurement selected from the group consisting of an integer multiple of the length of the first quiet period, a predetermined percentage of the length of the first quiet period, and a predetermined duration. The length of the third designated period may be longer than the length of the second designated period by a different measurement than used between the first designated period and second designated period. The first and second monitoring periods may correspond to a maximum backoff period for a contention-based access process plus a guard time.

### BRIEF DESCRIPTION OF THE DRAWINGS

Having thus described the invention in general terms, reference will now be made to the accompanying drawings, wherein:

FIG. 1 illustrates a cell phone sending a stored photograph or document to a printer through Wi-Fi for printing;

FIG. 2 illustrates Access Point (AP) and station functionalities implemented in software;

FIG. 3 illustrates rate differences in different networks that cause a SAP-enabled device to receive more packets than the SAP can handle, which wastes energy and may lead to packet drops;

FIG. 4 illustrates a SAP-enabled device cannot turn off its radio even when there is no traffic because of unpredictable packet arrivals;

FIG. 5 illustrates a system using a micro rate control algorithm that delays transmissions from STAs to delay packet arrivals and to allow AP to go to sleep in accordance with an embodiment of the invention;

FIG. 6 illustrates an embodiment in which a Queue Size subfield in received frames is used to estimate a traffic load;

FIG. 7 illustrates an exemplary embodiment of a traffic load estimation process; and

FIG. 8 illustrates another embodiment of the traffic load estimation process.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

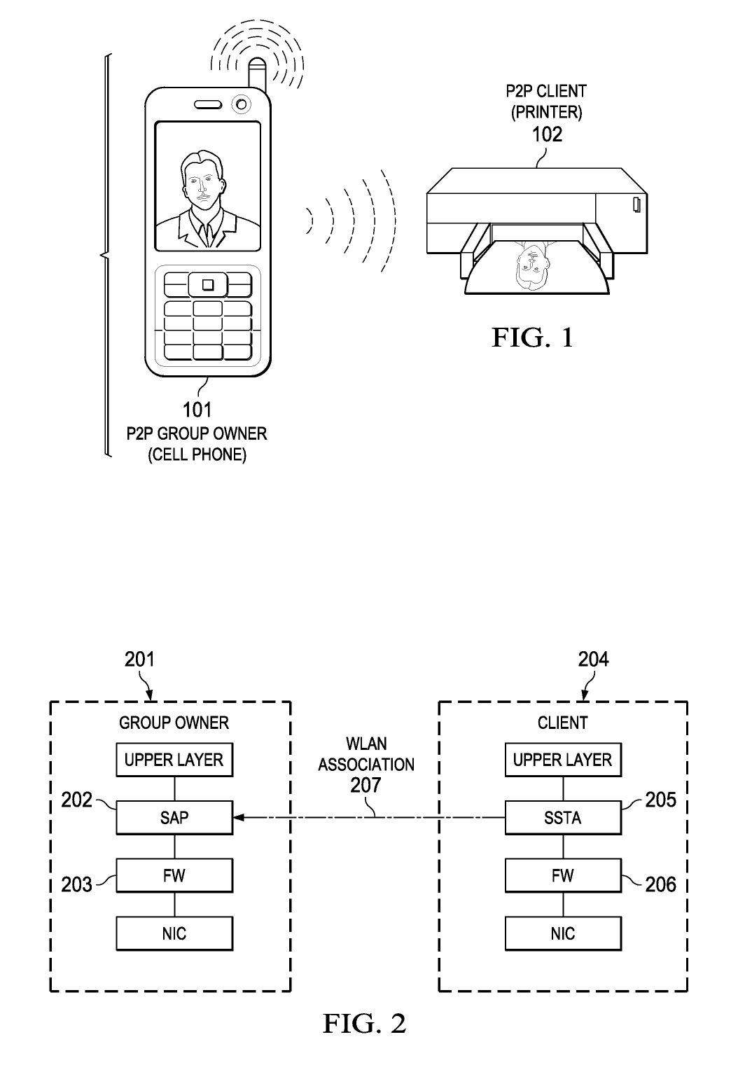

FIG. 1 illustrates a user connecting a CE device or mobile handset 101 to printer 102 through Wi-Fi technologies. This type of ad hoc Wi-Fi connection allows the user to use his cell phone to share, show, print, and synchronize content, such as photographs or documents, with other users. SAP-based cell phone 101 sends a stored photograph or document directly to printer 102 through an ad hoc Wi-Fi connection for printing without requiring a conventional AP or another infrastructure network nearby.

FIG. 2 illustrates Access Point (AP) and station functionalities implemented in software. Device 201, which may be a CE or mobile handset device, for example, includes software-based Access Point (SAP) functionality 202, which may be stored in firmware (FW) 203 or any memory structure in device 201. With the SAP functionality in device 201, another device, such as client device 204, can set up connections with SAP device 201 in the same way that client devices connect to a conventional AP. The client can be a conventional station or a device that includes software-based Station (SSTA) functionality 205, which may be stored in firmware 206 or any memory structure in client device 204. Device 201 acts as a group owner to establish an ad hoc WLAN association 207 with client 204.

If devices 201 and 202 are CE or mobile handsets, then the SAP based ad hoc solution illustrated in FIG. 2 must address limited battery capacity of device 201 and 202. One method of minimizing power consumption to operate more efficiently is to turn off the radio on device 201 and/or 204 when there is no traffic on the ad hoc WLAN network. In one embodiment, device 201 may use micro rate control in order to reduce energy consumption and to improve packet delivery ratio. Micro rate control allows device 201 to turn on its radio only long enough to support maximum end-to-end throughput of the ad hoc network. Such a device is disclosed in pending U.S. patent application Ser. No. 12/752,434, entitled “Improving Power Efficiency and Packet Delivery Ratio Through Micro Rate Control at Access Point Functionality Enabled Devices” and filed Apr. 1, 2010, the disclosure of which is hereby incorporated herein in its entirety.

Two of the most common uses of SAP are bridging to a cellular network and peer-to-peer data exchange. Because SAP typically runs on a mobile device that often has limited capacity in energy, computation and communication, SAP faces more challenges than convention AP.

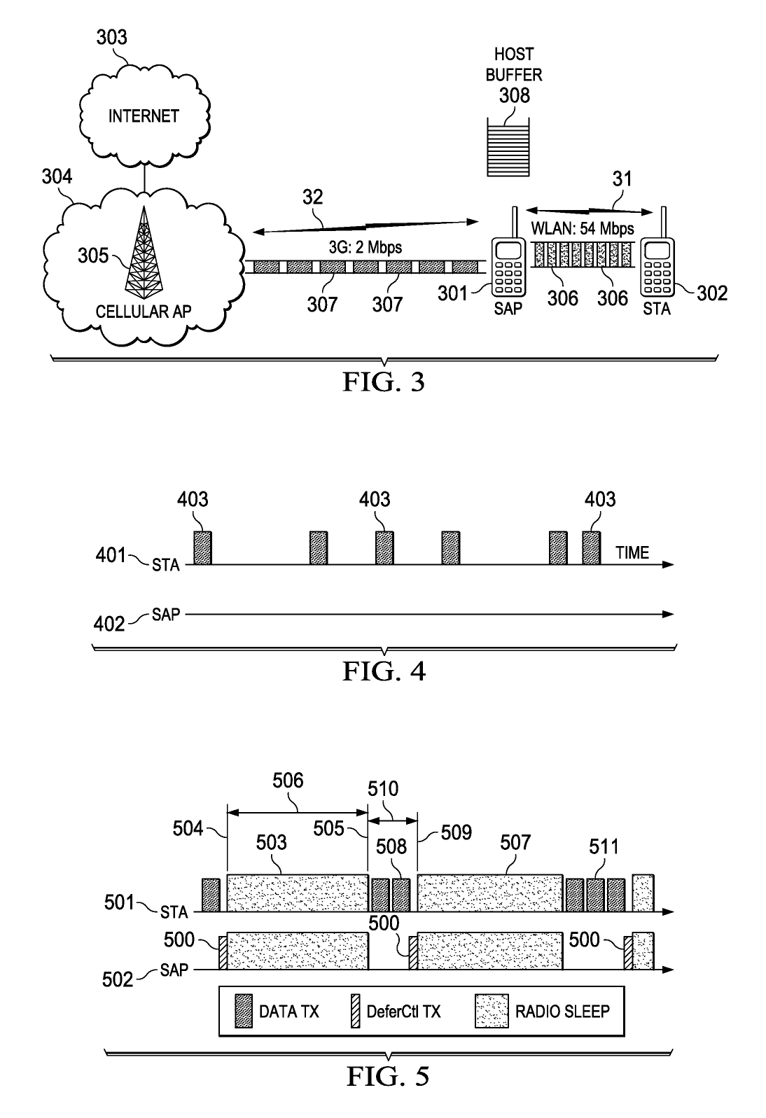

FIG. 3 illustrates an example of bridging to a cellular network. Cell phone 301 serves as a bridge between WLAN 31 and cellular network link 32. Cell phone 301 behaves as an SAP and allows cell phone 302 on the WLAN to access Internet 303 through cellular network 304 and cellular access point 305. Packets 306 are transmitted over the WLAN 31 between cell phones 301 and 302. Packets 307 are transmitted over a cellular network connection 32, such as a 3G cellular link, between cell phone 301 and cellular access point 305. In the illustrated embodiment, packets 306 and 307 are of the same size. Their respective widths in FIG. 3 are used to illustrate transmission delays on the different networks. Packets 306 on the WLAN link 31 are much narrower because they experience a much shorter transmission delay than those along the cellular network link 32. The WLAN link 31 is much faster than the cellular link 32. Although other embodiments of the cellular network could provide faster data transmission rates than the 2 Mbps illustrated in FIG. 3, so could other embodiments of the WLAN provide data rates faster than 54 Mbps. For example, when the IEEE 802.11n protocol is used on the WLAN, the rate difference between a WLAN link 31 and a cellular link 32 will be larger. Because the cellular link is only 2 Mbps, the realistic maximum end-to-end throughput is even lower than that. No matter how much throughput the WLAN link provides 31, the useful portion of the end-to-end connection is less than 2 Mbps. The rate difference between the WLAN network and the cellular network may cause SAP device 301 to receive more packets than it can handle, which wastes energy and may lead to packet drops.

In one embodiment of the invention, the WLAN radio cycle between two states: (1) on for a short period of time to support the less than 2 Mbps throughput; and (2) off for a long period of time to save energy. In the scheme described herein, the rate of incoming packets via the WLAN link is limited so that the SAP device 301 spends energy only for packets that the SAP device 301 can handle. To save energy, the rate-limiting scheme also puts SAP device 301 into a sleep mode when no packets are expected to arrive.

It will be understood that the present invention is not limited to transferring data packets across combined WLAN 31 and cellular network links 32 as described in the exemplary embodiment of FIG. 3. The connection between device 301 and 302 (e.g. network link 31) and/or between device 301 and 305 (e.g. network link 32) may be any associated with any wireless standard, such as any second generation (2G) cellular network technology and standards (using, for example, CDMA, TDMA, or GSM), third generation (3G) cellular network technology and standards (using, for example, EDGE, UMTS, or CDMA2000), and forth generation (4G) and later cellular network technology and standards (using, for example, LTE/SAE or MIMO). Alternatively, the wireless connections between device 301 and 302 and/or between device 301 and 305 may support any implementations or versions of the Wi-Fi (i.e. IEEE 802.11), WiMAX (i.e. IEEE 802.16), ZigBee, Bluetooth, HomeRF or any other peer-to-peer (P2P) or ad hoc communication protocols or standards.

In other embodiments, either or both link 31 and 32 may be a wireline interface. For example, SAP device 301 may be a battery-powered mobile handset capable of accessing Internet 303 via a wireline or Ethernet connection (not shown) and simultaneously communicating with one or more other devices (302) via a wireless connection.

The standard or protocol supporting links 31 and 32 may be the same or different on each link. Embodiments of the present invention control the flow of data across one or both links to ensure that packets received over a link with a fast throughput or data transmission rate do not overload the SAP device with packets that cannot be promptly transmitted over a link with a relatively slower throughput or data transmission rate.

It will be understood that devices 301 and 302 are not limited to cellular telephone devices. In alternative embodiments, devices 301 and 302 may be any mobile handset, “smart phone,” personal digital assistant (PDA), personal computer (PC), notebook computer, wireless network device (e.g., a personal computer having a wireless local area network (WLAN) network interface), press-to-talk personal communication services (PCS) device, iPhone, iPad, hand-held game system, electronic book, stereo component, television, or other wireless or Internet-enabled consumer electronics (CE) device.

FIG. 4 illustrates an example of a peer-to-peer data exchange use-case. For simplicity, only data transmission from the client (STA 401) to the SAP-enabled device (402) is shown. The inter-arrival time of data packets 403 is often random, resulting in bursty traffic. The SAP device 402 has to stay active fulltime in a receiving or listening mode because the packet 403 arrival times are unpredictable. Therefore, the SAP 402 spends excess energy powering its transceiver while in a waiting state without receiving any traffic. This situation, known as idle listening, is often true as most applications that do not occupy the medium full-time, such as web browsing and email. Even for streaming video, which uses a 8 Mbps rate, the WLAN medium is idle for more than 60% of the time when the WLAN data rate of 54 Mbps is used. This means that a conventional AP wastes energy for more than 60% of the time while waiting for incoming data. SAP 402 cannot turn off its radio even when there is no current traffic due to the unpredictable timing of packet arrival.

FIG. 5 illustrates the benefits of one solution to the above-noted problems in accordance with one embodiment of the invention. A micro rate control algorithm is used to delay transmissions from STA501 and to allow SAP 502 to go to sleep (i.e. power down its transceiver and/or processor) for a short period of time during this delay.

In this example, the SAP 502 generates a Defer Control (“DeferCtl”) frame 500, such as CTS2Self (clear to send to self) frame, a frame with large TXOP (transmission opportunity), or some other frame that could delay transmissions from STA501. Because SAP 502 knows that no packets will arrive during this period of time, the SAP 502 can safely turn off its radio in order to save energy. By using this DeferCtl frame, the algorithm achieves two goals at the same time. First, when the packet arrival rate is higher than what the SAP 502 can handle (as shown by WLAN packets in FIG. 3), the DeferCtl frames reduce the rate of packet arrivals. This rate control allows SAP 502 to go to sleep during intervals 503 to save energy, avoids buffer overflow, allows smaller buffer size at SAP 502, reduces workload of the host system of SAP 502, and helps STA's 501 to recognize congested network sooner. Second, when the packet arrival rate is lower than what the PHY rate can handle (as shown in the peer-to-peer data exchange scenario in FIG. 4), the algorithm regulates the way of packet arrivals. When the SAP 502 turns on its radio, there are often multiple waiting packets queued up at STA 502, allowing the channel to be fully utilized during the awake mode. At the same time, SAP 502 can go to sleep from time to time to save more energy.

In other embodiments, a specific type of control frame (referred to here as a Notification of Absence frame, or NOA) may be used by SAP device 502 to notify the STA device 501 that the SAP device will be unavailable for receiving during a specified period of time. The NOA control frame indicates a time at which the period of absence starts and may also indicate periodicity of such absence periods. As periodicity can be specified, a NOA control frame can replace multiple DeferCtl frames illustrated in FIG. 5.

The same strategy can also be applied to downlink traffic. Instead of transmitting all downlink traffic immediately, SAP 502 transmits DeferCtl to defer its own transmission and go to sleep if average traffic load is far below the throughput that can be supported by PHY rate. After this deferring, hopefully multiple packets have been accumulated at the SAP 502 and thus the SAP 502 can transmit them back-to-back, fully utilizing the channel capacity. SAP 502 preferably defers its transmission corresponding to Quality of Service (QoS) requirements of the packets. For example, a VoIP packet should not be deferred or should only be deferred for several milliseconds in order to maintain the desired QoS.

Embodiments of the present invention use the DeferCtl, TXOP, CTS2Self, Notice of Absence, or Opportunistic Power-Save frame or commands to optimize the end-to-end throughput of a network while minimizing the power usage of the SAP device that is receiving packets or bridging two different networks. The SAP device determines (1) when to enter a sleep mode during which the radio transceiver is turned off, and (2) how long to remain in the sleep mode and still balance the end-to-end throughput achievable by the SAP device.

The SAP device may designate transmission windows for STA device in any appropriate manner. For example, the SAP device may designate a period of absence during which it will be in a sleep mode, off-line or otherwise unavailable to receive data packets. The STA device buffers data packets during this period of absence and begins transmitting the buffered data at the end of the period of absence. The period of absence may be a single event or the SAP device may notify the STA client of two or more recurring periods of absence. The recurring periods of absence may be of a fixed or variable duration. The message or frame designating the period of absence may identify the start of the period of absence as occurring immediately or at a fixed future time. The message or frame may further define the period of absence as having a specific duration or may define a specific end time for the period of absence.

Alternatively, instead of defining a period of absence or unavailability, the SAP device may define one or more periods or windows during which it will be available to receive transmissions from the STA client. The message or frame designating the period or window during which the SAP device will receive data may also define a duration for the receive window. The start time of the receive window may be a single or reoccurring fixed or variable time. Similarly, the duration of the receive window may be of fixed or variable duration.

Referring to FIG. 5, SAP enabled device 502 may define a period of absence 503 having a particular start time 504 and end time 505 and/or duration 506. Subsequent periods of absence 507 may be defined having the same or different durations. Subsequent periods 507 may start at regular intervals or at variable times. Alternatively, SAP enabled device 502 may define a transmission window 508 during which its receiver will be powered on and ready to receive data packets. Transmission window 508 may be defined as having a start time 505 and end time 509 and/or duration 510. Subsequent transmission windows 511 may also be defined. Subsequent transmission windows 511 may have the same, different or variable durations compared to window 508 and may occur at fixed or variable intervals.

Although a period of absence or transmission window is defined by SAP-enabled device 502, it may actually power-up and operate its receiver, transmitter, processor, buffers and/or other components earlier than period of absence end time/transmission window start time 505 to provide a guard time in situations where the clock or timing of STA client device is not adequately synchronized. Similarly, SAP-enabled device 502 may actually power-down its receiver, transmitter, processor, buffers and/or other components and enter a sleep-mode later than period of absence start time/transmission window end time 509 to provide a guard time.

The length of intervals 503, 507 are variable and are selected based upon current conditions of the network as known to SAP 502. Embodiments of the invention define the sleep intervals or periods of absence so as to maximize power saving in the SAP without causing degradation of the overall network operation.

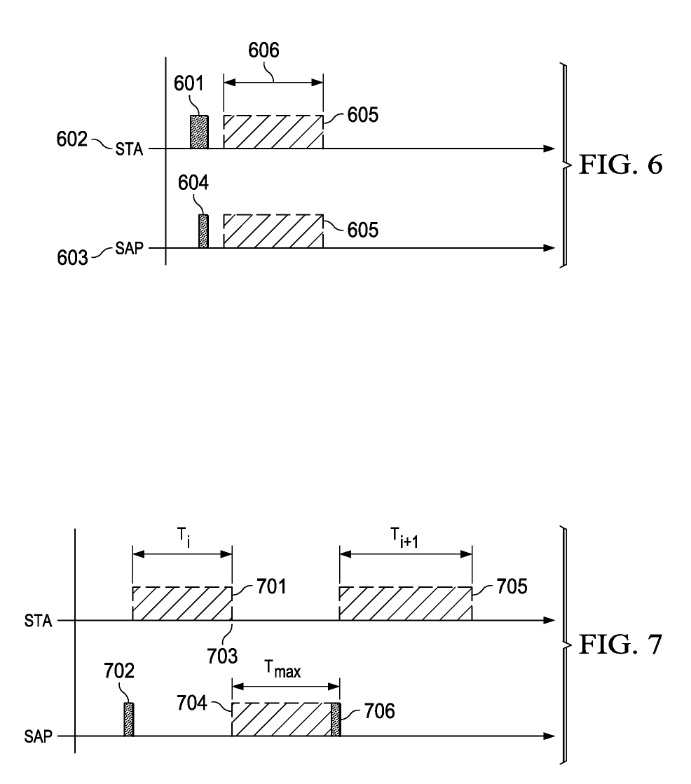

FIG. 6 illustrates one embodiment in which a “Queue Size” subfield in received frames is used to estimate the traffic load in the network. The “Queue Size” subfield is located in a “QoS Control” field of data frames 601 sent from QoS-enabled STA 602 to SAP 603. The Queue Size subfield indicates how many pending packets in a queue at STA 602 are associated with the same access category or the same stream as transmitted packet 601. Using this information, SAP 603 can estimate the number of pending packets at STA 602. If there are pending packets, then SAP 603 evaluates the pending packet backlog and the system requirements to determine whether STA 602 should be allowed to continue to send packets. If the Queue Size parameter indicates that there are no pending packets, then the SAP can turn off its radio for a short period of time.

In one embodiment, when the Queue Size indicates that STA 602 is not waiting to send additional packets, then SAP 603 sends DeferCtl frame 604, which instructs STA 602 to not transmit packets during period of absence or sleep interval 605. The duration 606 of interval 605 may be a preset length that is used for each period of absence or may be a variable length that is selected by SAP 603.

The Queue Size technique works well when there is ongoing traffic and all STAs set the Queue Size subfield. However, the Queue Size subfield is not always set by the stations. The Queue Size technique is not helpful when there is no ongoing traffic or when the Queue Size subfield is not set by the STA. To estimate traffic loads in these cases, an adaptive process based on exponential backoff can be used to the estimate traffic load. This process calculates when to generate a DeferCtl frame, such as a CTS2Self, TXOP, Notice of Absence, or Opportunistic Power-Save frame, and determines the length of SAP sleep period.

FIG. 7 illustrates one embodiment of a traffic load estimation process. T, is the duration of the i^{th} time interval 701, which has been designated by DeferCtl frame 702. The network is commanded to be quiet during interval 701. The stations do not send any data packets during interval 701 and the SAP enters a sleep mode. Following the end (703) of time interval 701, the SAP wakes up—i.e. powers on its radio—for a predetermined time interval 704 to listen to the medium for new packets.

In one embodiment, Tₘₐₓ, represents the maximum access delay before a STA would start transmitting its pending data following quiet period 701. In a contention-based network, for example, Tₘₐₓ may be the maximum backoff window size plus some extra delay or guard period. If no packet is received by the SAP device during the Tₘₐₓ time interval 704, then the SAP can assume that no STA device has packets to send at the current time. The SAP device may generate another quiet period by sending the next DeferCtl frame 706 after a monitoring window of time Tₘₐₓ elapses. In this situation, if a packet has not been received by the SAP device during period 704, then the SAP device may increase the length (Tᵢ₊₁) of a subsequent quiet interval 705 that is protected by next DeferCtl frame 706.

In one embodiment, the length (Tᵢ₊₁) of period 705 may be some multiple of the length (Tᵢ) of period 701 (e.g. Tᵢ₊₁=x·Tᵢ). In another embodiment, the length (Tᵢ₊₁) of period 705 may be longer than Tᵢ by some preselected amount, such as a set number of milliseconds (e.g. Tᵢ₊₁=Tᵢ+x ms) or a set percentage increase (e.g. Tᵢ₊₁=Tᵢ+x %·Tᵢ). For example, after a first quiet period, if no packets are received from the STA, the SAP may designate a second quiet period that is twice as long as the previous period, or 10 ms longer than the previous period, or 10 percent longer than the previous period. This allows the SAP device to optimize the quiet period for current network conditions. If there are no packets transmitted following the i^{th} quiet period, the SAP device extends the following (i+1) quiet period by a predetermined amount. This allows the quiet period to grow longer over each iteration. It will be understood that other methods or a combination of the above-listed methods for extending the quiet period may be used. For example, the quiet period may be doubled after a first monitoring window and increased linearly following subsequent monitoring windows in which no packets are received from the client stations.

Alternatively, if the SAP device receives a packet during period 704, then the SAP device keep its radio on for a designated period to determine if any more packets are received from a STA device. After receiving a packet, the SAP device may keep its radio on for a predetermined interval, such as another Tₘₐₓ length of time, before sending the next DeferCtl frame. If a packet is received before the time Tₘₐₓ elapses, then the SAP device may restart a timer for another Tₘₐₓ period. When the Tₘₐₓ period elapses without receipt of a packet, then the SAP device generates another DeferCtl frame to designate a new quiet interval. The length of the new quiet interval may be a standard initial value, (Tᵢ) or the length of the last quiet period (Tᵢ₊₁).

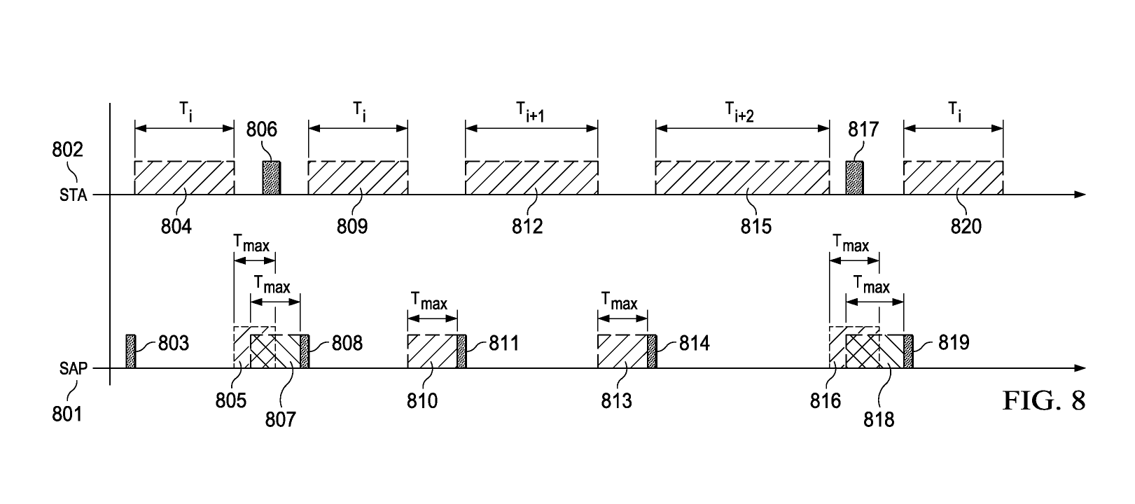

FIG. 8 illustrates another embodiment of the traffic load estimation process. After SAP device 801 has not received a packet from STA device 802 for a predetermined period, then SAP 801 transmits DeferCtl frame 803 designating quiet interval 804 having duration Tᵢ. At the end of period 804, SAP 801 turns on its radio for period 805 having duration Tₘₐₓ, and waits to receive any packets from STA 802. If packet 806 is received from STA 802 during listening period 805, the SAP restarts a new listening period 807 having duration Tₘₐₓ and waits for additional packets.

The access point adapts to increasing traffic loads in this way by extending or restarting the monitoring period. When packet 806 is received or transmitted during monitoring period 805, then access point 801 restarts the monitoring period and monitors the channel for additional packets during period 807. STA device 802 may notify access point 801 during the monitoring period 805 that device 802 has pending packets for transmission. Access point 801 immediately restarts the monitoring period 807 to allow STA 802 to transmit the pending packets 806.

If no packets are received during period 807, then SAP 801 transmits DeferCtl frame 808 designating new quiet period 809 having duration Tᵢ. At the completion of quiet period 809, SAP 801 turns on its radio and listens for period 810 having duration Tₘₐₓ for additional packets. If no packets are received during period 810, then SAP 801 transmits DeferCtl 811 designating quiet period 812 having duration Tᵢ₊₁. As noted above, the duration Tᵢ₊₁ may be a multiple of duration Tᵢ or an extension of duration Tᵢ by some fixed value or percentage.

At the end of period 812, SAP 801 again turns on its radio and listens for additional packets during period 813 having duration Tₘₐₓ. If no packets are received during period 813, then SAP 801 transmits DeferCtl 814 designating quiet period 815 having duration Tᵢ₊₂. The duration Tᵢ₊₂ is preferably longer than duration Tᵢ₊₁. For example, Tᵢ₊₂ may be a multiple of duration Tᵢ₊₁ or an extension of duration Tᵢ₊₁ by some fixed value or percentage.

At the end of period 815, SAP 801 turns on its radio during period 816 having duration Tₘₐₓ. Packet 817 is received by SAP 801 during period 816. After receiving packet 817, SAP 801 listens for period 818 having duration Tₘₐₓ for additional packets. If no packets are received during period 818, the SAP 801 transmits DeferCtl frame 819 designating new quiet period 820. In this example, because new quiet period 820 follows the receipt of a new packet 818, the duration of period 820 is reset to initial value Tᵢ.

The protected time intervals Tᵢ, Tᵢ₊₁, Tᵢ₊₂ that are set by the DeferCtl frames should not cause packets to back up at the STA and should not impact overall network quality. Accordingly, the value of Tᵢ is bounded by a threshold value D_{P} (i.e. Tᵢ<D_{P}) that is selected to assure that QoS requirements are met by the transmitted packets. A threshold value D_{P} must be designated in the network to prevent the value of Tᵢ from growing to an unuseable value. Without the limit D_{P}, the quiet period Tᵢ would become so long as to allow an excessive number of packets to fill the queue at STA 802.

The value of D_{P} may be calculated based on the expected network throughput, for example, estimated by a scheme such as an exponential moving average function. D_{P} should be small enough that the quiet periods will not result in a degradation of network throughput and/or quality of service. For example, if voice traffic is being carried by the packets, then the QoS may require that the packets have a maximum delay (i.e. D_{P}) of 20 ms. Under these circumstances, the value of Tᵢ would be limited to 20 ms.

The value of D_{P} has a lower limit. If current network conditions result in a D_{P} that is below a threshold that does not provide any benefit for turning off the radio, then the SAP device should keep its radio on. For example, D_{P} should not cause the SAP device to turn its radio off and on so quickly that there is effectively no power savings. The lower limit of D_{P} may be determined in one embodiment by evaluating whether the improvement or power savings achieved by DeferCtl frames is greater than a certain percentage. If the minimum improvement cannot be achieved (i.e. when D_{P} drops below the lower threshold), then the SAP device should withhold from transmitting DeferCtl frames until network conditions cause D_{P} to increase above the minimum-improvement threshold.

Under current network conditions, D_{P} may be larger than the maximum duration that can be designated by a DeferCtl frame. In this situation, the SAP device can take advantage of the potential energy savings of an extended quiet period generating another DeferCtl at the end of an initial protected interval to defer STA transmissions for the full D_{P} time. For example, a CTS2Self frame can only designate a quiet period of 32 ms maximum. If D_{P} is greater than 32 ms, then consecutive CTS2Self frames can be sent to extend the quiet period beyond the initial 32 ms.

Embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine, such as a computer. For example, a machine-readable medium may include a tangible storage medium, such as but not limited to read only memory (ROM), random access memory (RAM), magnetic disk storage media, optical storage media, flash memory devices and the like.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. An access point, comprising:
a wireless receiver for receiving data from a network;
a wireless transmitter for transmitting data to one or more devices on the network;
a processor coupled to the receiver and the transmitter, the processor adapted to process data packets received from the network and to generate messages to be transmitted to the one or more devices, the processor operating to:
send first transmit instructions to the one or more devices, the first transmit instructions identifying a first period of absence;
monitor a transmit channel during a monitoring period following the first period of absence; and
when no packets are received during the monitoring period, send second transmit instructions to the one or more devices, the second transmit instructions identifying a second period of absence.

2. The access point of claim 1, wherein the second period of absence is equal to or longer than the first period of absence.

3. The access point of claim 1, further comprising:
when one or more packets are received or transmitted during the monitoring period, restarting the monitoring period and monitoring the transmit channel during a new monitoring period.

4. The access point of claim 1, further comprising:
when the one or more devices on the network notify the access point that packets are pending at the device, extending the monitoring period to handle the pending packets before a next period of absence.

5. The access point of claim 1, the processor further operating to:
place the receiver in a sleep mode during at least a portion of the period of absence, the sleep mode preventing the receiver from receiving data from the network; and
place the receiver in an active mode at times outside the period of absence.

6. The access point of claim 1, further comprising:
a memory coupled to the processor, the memory storing access point functionality software.

7. The access point of claim 1, wherein each set of transmit instructions further identify a start time and a duration for the period of absence and an interval separating a plurality of periods of absence.

8. The access point of claim 1, wherein a length of the second period of absence is an integer multiple of a length of the first period of absence and wherein the integer is 1 or greater.

9. The access point of claim 1, wherein a length of the second period of absence is longer than a length of the first period of absence by a predetermined percentage.

10. The access point of claim 1, wherein a length of the second period of absence is longer than a length of the first period of absence by a predetermined duration.

11. A method, comprising:
instructing a device to not transmit during a first quiet period;
monitoring a transmission medium during a monitoring period following the first quiet period;
when no data is received from the device during the monitoring period, instructing the device to not transmit during a second quiet period, the second quiet period longer than the first quiet period; and
when the device indicates that data is pending during the monitoring period, restarting the monitoring period after data is received from the device and monitoring the transmission medium during a new monitoring period.

12. The method of claim 11, further comprising:
placing a receiver in a sleep mode during at least a portion of the first quiet period;
placing the receiver in an active mode during the monitoring period; and
returning the receiver to the sleep mode during at least a portion of the second quiet period.

13. The method of claim 11, wherein a clear to send to self (CTS2Self) frame is used to instruct the device to not transmit.

14. The method of claim 11, wherein a transmission opportunity (TXOP) frame is used to instruct the device to not transmit.

15. The method of claim 11, wherein a notice of absence (NoA) or an opportunistic power-save message is used to instruct the device to not transmit.

16. The method of claim 12, wherein the placing the receiver in an active mode occurs prior to a start time of the monitoring window.

17. The method of claim 11, wherein a length of the second quiet period is an integer multiple of a length of the first quiet period and wherein the integer is 1 or greater.

18. The method of claim 11, wherein a length of the second quiet period is longer than a length of the first quiet period by a predetermined percentage.

19. The method of claim 11, wherein a length of the second quiet period is longer than a length of the first quiet period by a predetermined duration.

20. A method, comprising:
notifying a station on a wireless network that an access point will not receive transmissions during a first designated period;
monitoring the wireless network during a first monitoring period, the first monitoring period beginning at an end of the first designated period;
when no transmission is received from the station during the first monitoring period, notifying the station that the access point will not receive transmissions during a second designated period, the second designated period having a longer duration than the first designated period;
monitoring the wireless network during a second monitoring period, the second monitoring period beginning at an end of the second designated period, a duration of the second monitoring period corresponding a duration of the first monitoring period; and
when no transmission is received from the station during the second monitoring period, notifying the station that the access point will not receive transmissions during a third designated period, the third designated period having a longer duration than both the first designated period and the second designated period.

21. The method of claim 20, wherein a length of the second designated period is longer than a length of the first designated period by a measurement selected from the group consisting of: an integer multiple of the length of the first quiet period, a predetermined percentage of the length of the first quiet period, and a predetermined duration.

22. The method of claim 21, wherein a length of the third designated period is longer than the length of the second designated period by a different measurement than used between the first designated period and second designated period.

23. The method of claim 20, wherein the first and second monitoring periods correspond to a maximum backoff period for a contention-based access process plus a guard time.

24. The method of claim 20, further comprising:
determining a maximum designated-period value based upon the quality of service requirements of the wireless network.
